(19) United States
(12) Patent Application Publication
(10) Pub. No.: US 2025/0175214 A1
(43) Pub. Date: May 29, 2025

(54) RECONFIGURABLE INTELLIGENT SURFACES USING FERROELECTRIC MATERIALS

(71) Applicant: Dell Products L.P., Round Rock, TX (US)

(72) Inventors: Navjot Kaur Khaira, Kanata (CA); Tejinder Singh, Kanata (CA); Morris Repeta, Ottawa (CA)

(21) Appl. No.: 18/523,081

(22) Filed: Nov. 29, 2023

(51) Int. Cl. H04B 7/04

(52) U.S. Cl. CPC H04B 7/04013

(57) ABSTRACT

A reconfigurable intelligent surface is disclosed. The reconfigurable intelligent surface includes a ferroelectric layer. Applying a voltage to the ferroelectric layer changes the dielectric constant of the reconfigurable intelligent surface. This allows a signal to be reflected to be steered in a continuous manner by changing the voltage. The reconfigurable intelligent surface may be a panel that includes multiple cells arranged to reflect and steer an incident signal.

### FIELD OF THE INVENTION

Embodiments of the present invention generally relate to reconfigurable intelligent surfaces. More particularly, at least some embodiments of the invention relate to systems, hardware, software, computer-readable media, and methods for reconfigurable surfaces that include ferroelectric materials.

### BACKGROUND

Cellular wireless communication is primarily based on 5G technology. 5G wireless networks was intended to deliver Gigabit data speeds, low latencies, and an improved user experience. These goals have been generally achieved. The telecom industry, however, is working to deliver sixth generation (6G) wireless communications.

Current radio frequency (RF) bands (5G bands) are largely saturated. As a result, the next logical step is to tap into the less saturated higher frequency bands. This approach, however, presents new challenges. For example, higher frequencies correspond to smaller wavelengths. Signals at these frequencies can be adversely impacted by physical barriers (e.g., buildings, vehicles, trees). The physical barriers can absorb, reflect, or scatter these higher frequency signals. Thus, these higher frequency signals may experience loss in free space. Establishing countless transceiver points for line-of-sight communications seems impractical.

A potential solution that has recently emerged includes reconfigurable intelligent surfaces (RIS) or intelligent reflective surfaces (IRS). A reconfigurable intelligent surface is a sophisticated assembly of hundreds, sometimes even thousands, of individual metamaterial unit cells. Currently, most of these unit cells require components such as PIN diodes, varactors, and/or switches to operate effectively. However, the binary nature of each switch or diode (on/off) presents a limitation. The presence of two states inevitably restricts the possible phase outcomes of the signal.

In addition to the restrictions on the phase outcome, current reconfigurable intelligent surface technologies present other issues. For example, conventional technologies require the signal to be received, actively processed (e.g., amplify and forward (AF), decode and forward (DF)), and retransmitted. Processing the signal can negatively impact the signal quality. AF, for example, can lead to noise amplification and DF can introduce decoding errors. Additionally, AF and DF cannot be readily incorporated into existing infrastructure like building walls or billboards due to at least the processing and amplification (e.g., power) requirements.

Conventional RIS technologies include the use of PIN diodes/varactors. PIN diodes and varactors have been extensively used in radio frequency (RF) applications due to their switching and tuning capabilities. However, several characteristics limit their effectiveness with respect to millimeter-wave (mmWave) applications. As the operating frequency increases, the parasitic capacitance and inductance associated with the device layout become more pronounced. These parasitic elements can resonate with the junction capacitance of the diodes, causing a significant degradation in performance and limiting the overall operational bandwidth. Both PIN diodes and varactors have a maximum operating frequency and their performance drops drastically at frequencies above their maximum operating frequency.

PIN diodes are often used to implement reconfigurable properties in reconfigurable intelligent surfaces because they can act as variable resistors or switches when controlled by a bias current. This allows a level of control over the electromagnetic response of each element. However, the reconfigurability achieved using PIN diodes has certain limitations.

For example, a common application of PIN diodes in reconfigurable intelligent surfaces involves their use as binary switches. In this role, PIN diodes can only provide two phase states (e.g., 0° and 180°). This binary control limits the precision of phase tuning and, consequently, the resolution of beam steering and wavefront shaping.

PIN diodes also require a bias current to change their state and actively consume power. This power consumption can become an issue, particularly in large-scale reconfigurable intelligent surface systems that include large numbers of PIN diodes or varactors.

Next, in the active state, PIN diodes operate in a nonlinear region. This can lead to distortions in the signal passing through them, especially at high power levels. This distortion can degrade the quality of the signal and reduce the effectiveness of the reconfigurable intelligent surface.

In addition, the speed at which a PIN diode can switch states (and thus the speed at which the RIS can be reconfigured) is determined by the carrier lifetime in the diode. While this is typically fast enough for many applications, there are many high-speed scenarios in which the switching speed is inadequate.

Implementing PIN diodes on a reconfigurable intelligent surface introduces additional design complexity and cost, as each diode requires its own biasing network. In addition, the fact that each diode needs to be individually controlled to achieve the desired global effect can lead to challenges in terms of control complexity and efficiency.

With the transition to higher frequencies such as may be used in 6G applications, the physical dimensions of these components and the circuit become an important factor. Designing compact, integrated circuits with PIN diodes or varactors that can operate at millimeter-wave frequencies can be challenging.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a top perspective of unit cell of a reconfigurable intelligent surface that has a dielectric constant that can be varied;

FIG. 1B discloses aspects a bottom perspective of the unit cell in FIG. 1A;

FIG. 1C discloses aspects of a cross sectional view of the unit cell of FIG. 1A;

FIG. 1D discloses aspects of a panel that includes multiple unit cells arranged in a grid formation;

FIG. 2 discloses aspects of a relative reflection phase of a reconfigurable intelligent surface;

FIG. 3 discloses aspects of beam steering using a reconfigurable intelligent surface;

FIG. 4 discloses aspects of deploying panels or reconfigurable intelligent surfaces in an environment;

FIG. 5 discloses aspects of deploying panels or reconfigurable intelligent surfaces in another environment;

FIG. 6 discloses aspects of a method for deploying and operating panels or reconfigurable intelligent surfaces; and

FIG. 7 discloses aspects of a computing device, system, or entity.

### DETAILED DESCRIPTION OF SOME EXAMPLE EMBODIMENTS

Embodiments of the present invention generally relate to reconfigurable intelligent surfaces (RISs). More particularly, at least some embodiments of the invention relate to systems, hardware, software, computer-readable media, and methods for reflecting/transmitting electromagnetic signals or waves using reconfigurable intelligent surfaces.

Reconfigurable intelligent surfaces or intelligent reflective surfaces (IRSs) are examples of metasurfaces that can manipulate or control the direction, phase, amplitude, and/or polarization of incident electromagnetic waves or signals. A reconfigurable intelligent surface is typically an assembly of hundreds or thousands (or more) of individual metamaterial unit cells.

Embodiments of the invention relate to reconfigurable intelligent surfaces that incorporate a ferroelectric material such as barium strontium titanate (BST). A reconfigurable intelligent surface with BST in the unit cells allows the unit cells to be tuned individually and allows for a variable or continuous phase shift of the reflected signal. Embodiments of the invention are not limited to a set of discrete possible reflection directions, but can reflect a signal across a continuum. Embodiments of the invention relate to a reconfigurable intelligent surface that can provide a continuous phase shift using a ferroelectric material.

Embodiments of the invention relate to a reflective surface that is configured to operate with respect to electromagnetic signals. Embodiments of the invention are discussed in the context of mm (millimeter) wave signals (e.g., 30-300 GigaHertz (GHz) or 10 mm to 1 mm), but are not limited to signals or waves in these frequencies. Embodiments of the invention may also be used with signals in the 5G-FR1 Bands and 5G-FR2 bands. Embodiments of the invention, however, may operate at other frequencies in addition to 5G and 6G frequencies. Embodiments of the invention may be adapted to wireless signals in wireless networks, cellular wireless networks, or the like.

In one example, the reconfigurable intelligent surface may be embodied as a panel that includes multiple individual unit cells that can be controlled individually. The panel may be fabricated such that the unit cells are formed monolithically in the panel. The reconfigurable intelligent surface is configured with a ferroelectric material, such as barium strontium titanate (BST), and is configured or controlled to reflect an incident signal. The reflection can be controlled or steered in a continuous manner. Thus, the panel is reconfigurable as the reflection direction can be controlled.

In one embodiment, a reconfigurable intelligent surface includes a plurality of unit cells arranged, by way of example only, in a grid form or an array form. The phase response of each unit cell can be tailored to compensate for different spatial lengths from the feed (e.g., signal source) in order to achieve a constructive interference in the desired direction.

During the fabrication process, BST or other ferroelectric is seamlessly integrated into each unit cell to generate a monolithic structure such as a panel. Integrating BST in this manner allows for high operating frequencies due to the absence of interconnects between the tuning element and the reflecting element. Further, the need for soldering or wire bonding is eliminated.

Thin-film BST enables variable dielectric constants in the monolithic structure. More specifically, changing the voltage across or applied to the ferroelectric layer can change the dielectric constant of the unit cell. Thus, the phase of the reflected signal from each unit cell can be controlled. In other words, individually controlling the phase imparted by each unit cell is achieved by selectively modulating the voltage supplied to the BST layer. The response time of BST is in the nanosecond range, which enables swift beam scanning and facilitates the implementation of multiple beamforming applications.

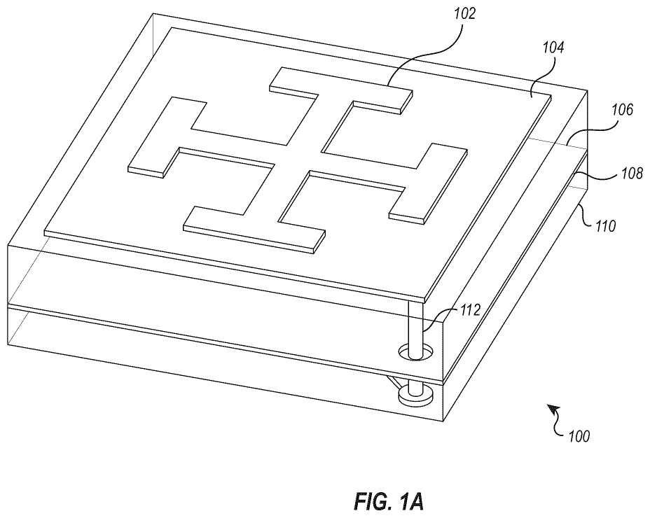

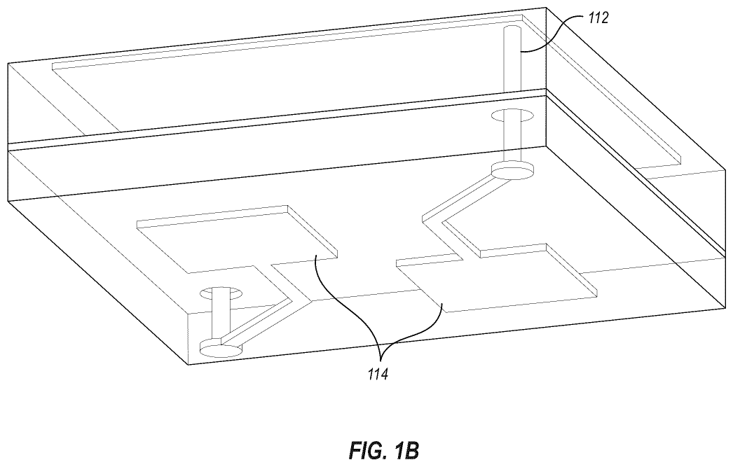

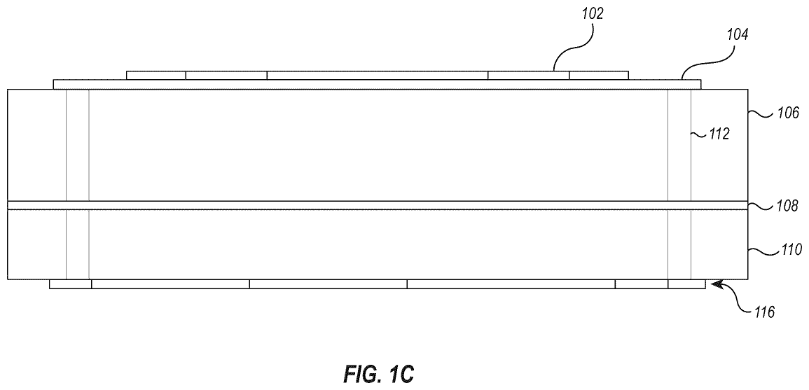

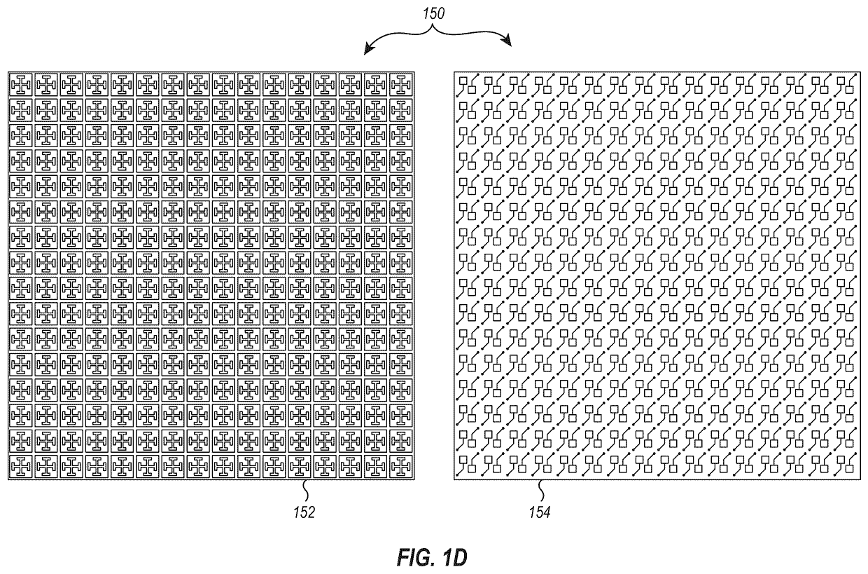

FIG. 1A, 1B and 1C disclose aspects of a unit cell from different perspectives. FIG. 1A discloses a top perspective view of the unit cell. FIG. 1B discloses aspects of a bottom perspective view of the unit cell. FIG. 1C discloses aspects of a cross-sectional view of the unit cell.

FIGS. 1A-1C illustrate a unit cell 100. The unit cell 100 in FIGS. 1A-1C illustrates various layers of a of a unit cell that may be included in a reconfigurable intelligent surface. With reference to FIG. 1C, the unit cell 100 includes a top metal layer 102, a ferroelectric layer 104, a substrate layer 106, a ground metallic layer 108, a substrate 110, and a biasing layer 116. The substrates 108 and 110 are separated by the ground metallic layer 108. The substrates 106 and 110 may be formed using different materials. Example materials for the substrates 106 and 110 include silicon (Si) and FR4 (a type of printed circuit board material that may include epoxy resin and glass composite), glass, sapphire, quartz, rogers RF or the like. In a particular unit cell, the substrates 106 and 110 may be formed of the same or different materials.

The ferroelectric layer 104 is disposed between the top metal layer 102 and the substrate 106. In one example, the ferroelectric layer 104 of the unit cell 100 does not completely cover the top surface of the substrate 106. The length and width dimensions of the ferroelectric layer 104 are smaller than the length and width dimensions of the substrate 106. When the unit cells are arranged in a panel (or fabricated as a panel), the ferroelectric layers of the individual unit cells are isolated from each other and do not contact each other.

More specifically during fabrication, a uniform thin layer 104 of ferroelectric material BST is deposited on the top substrate 106 using techniques such as pulsed laser deposition (PLD), chemical solution deposition (CSD), metal-organic chemical vapor deposition (MOCVD), RF magnetron sputtering or the like. The ferroelectric layer 104 is then patterned and etched to form a square patch in each unit cell 100 of a reconfigurable intelligent surface.

On this square patch of ferroelectric material (the ferroelectric layer 104), a layer of copper or other suitable material or metal is formed, selectively patterned and etched to form the top metallic layer 102. The shape of the metal layer 102 may vary. FIG. 1A illustrates a top metal layer 102 with a cross or “X” type shape. Generally, the metal layer 102 is configured to have a shape such that the metal layer 102 is resonant with the incident signal or electromagnetic wave of interest.

More generally, the unit cell 100 may be sized in order to operate with an intended frequency of range of frequencies.

The unit cell 100 also includes vias 112. The vias 112 connect the bias pads 114 to the ferroelectric layer 104. The bias pads 114, which are part of the biasing layer 116 and which may be formed using patterning and etching techniques, allow a voltage to be placed across or applied to the ferroelectric layer 104. A V+ is connected to one of the bias pads 114 and a V− is connected to the other of the bias pads 114.

The reflection properties of the unit cell 100 are dependent on the mode of excitation, the physical parameters of the patch or ferroelectric layer 104, and the dielectric properties of the ferroelectric layer 104 and/or the substrate 106. Placing a voltage across the ferroelectric layer 104 and changing the voltage across the ferroelectric layer 104 may change a dielectric constant of the ferroelectric layer 104. This allows the dielectric constant of the unit cell 100 to be variable. By changing the dielectric constant of the ferroelectric layer 104, the phase of the reflected signal can be controlled continuously. Consequently, the resonant frequency and reflection phase of the unit cell can be controlled. Embodiments of the invention thus relate to unit cells and reconfigurable intelligent surfaces that can be tuned continuously. This allows the phase of the reflected signal to be controlled and allows the direction to be controlled in a continuous manner.

Using PIN diodes or varactors, in contrast, limits the ability to determine the phase of the reflected signal and results in limited phase states and limited beam directions.

FIG. 1D discloses aspects of a panel or reconfigurable intelligent surface that includes multiple unit cells. FIG. 1D illustrates a monolithic panel 150. More specifically, a top view 152 of the panel 150 illustrates that that the individual cells are arranged in a grid pattern that may have any desired dimension. In one example, the panel 150 may have a square configuration. However, the panel 150 may have a rectangular configuration. Embodiments of the invention are not limited to these geometric configurations and may be circular, oval, or other shape that may not be symmetrical. Further, the geometric configuration of the unit cells in the panel 150 may vary according to available deployment space. The top view 152 illustrates that the ferroelectric layers and top metal layers of the individual unit cells are separated from each other.

The bottom view 154 illustrates that each unit cell is associated with bias pads 114. The bias pads 114 allows the voltage of each unit cell to be controlled independently of the voltage applied to other unit cells.

By controlling the voltages applied to the individual cells of the panel 150, the permittivity of the ferroelectric layer is tuned to its paraelectric behavior. This allows a variable dielectric constant to be realized. As a result, the resonant frequency and reflection phase of each unit cell can be continuously and independently controlled, giving a combined effect of beam-steering from the panel 150.

Thus, the panel 150 can be used to reflect an incident electromagnetic wave in a desired direction by controlling the dielectric constant of each of the unit cells in the panel 150.

In one example, a full-wave electromagnetic simulation was performed using a commercial finite element modeler electromagnetic simulation application to view the effect of varying a value of a dielectric constant on the performance of the unit cell. In this example, the dielectric constant was varied from 220 to 380 for an E-field variation of 0 to 18 V/μm. In this example, the unit-cell analysis is conducted for a normal incidence angle. The analysis is carried out by varying the dielectric constant of the ferroelectric layer from 220 to 380 in steps of 20.

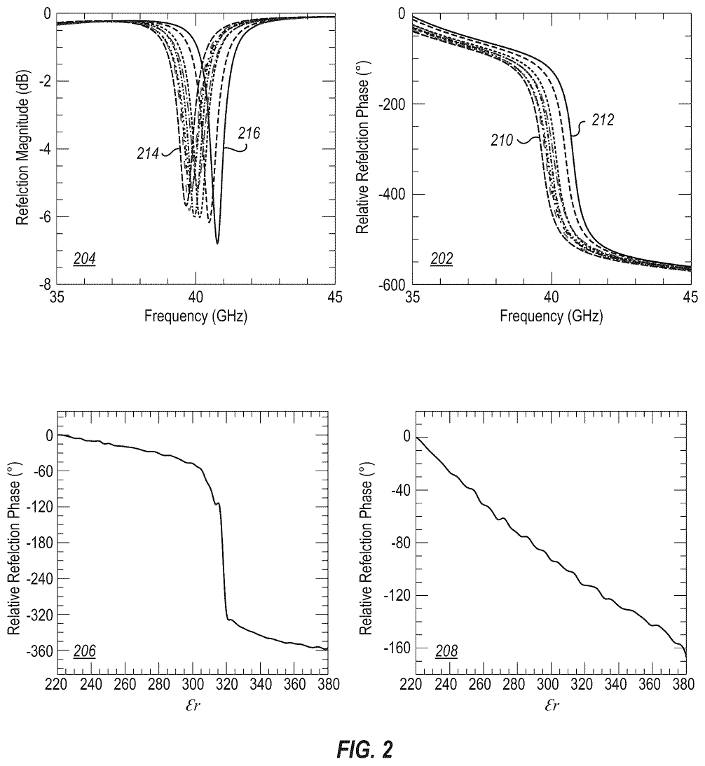

FIG. 2 discloses aspects of this experiment. The graph 202 illustrates a reflection phase and magnitude variation for the unit cell. In this example, the substrate is silicon and the top metal layer is copper. The graph 202 and the graph 204 illustrate the reflection phase and magnitude variation for the unit cell assuming that the substrate is silicon, the top metal is copper, and the ferroelectric layer is BST. As the voltage across the BST layer is increased, the dielectric constant changes from 220 to 380 and the resonant frequency shows a change of around 1 GHz. The graph 202 illustrates a curve 210 associated with a dielectric constant of 380 and the curve 212 is associated with a dielectric constant of 220. Similarly, the curves 214 and 216 are associated with, respectively, dielectric constants of 380 and 220. The other curves correspond to dielectric constants whose values are between 220 and 380.

The graphs 206 and 208 illustrate a change in reflection phase with the change in dielectric constant. The graph 206 is associated with a silicon substrate and the graph 208 is associated with an FR4 substrate. A relative tunable phase of 360° can be observed when using a silicon substrate while a reduced phase tunability of about 168° is observed with an FR4 substrate.

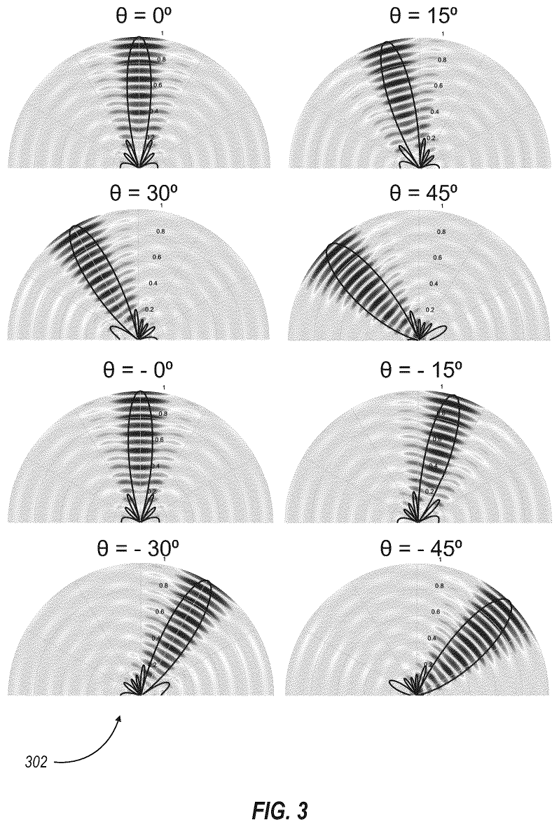

FIG. 3 discloses aspects of tuning a reconfigurable intelligent surface. FIG. 3 illustrates 8 different reflections 302 achieved with a panel, such as the panel 150 for an incident beam normal to the surface. However, because voltage applied to the ferroelectric layer can vary in a continuous manner, the direction of the reflected beam or signal can also be changed continuously. This allows the beam to be reflected in a specific direction and allows the reflection direction to be changed by simply changing the voltage applied to the ferroelectric layer of the unit cells in the panel.

Reconfigurable intelligent surfaces can be configured to extend the coverage of wireless networks. A reconfigurable intelligent surface can reflect an incoming signal around obstacles where direct transmission is undesirable.

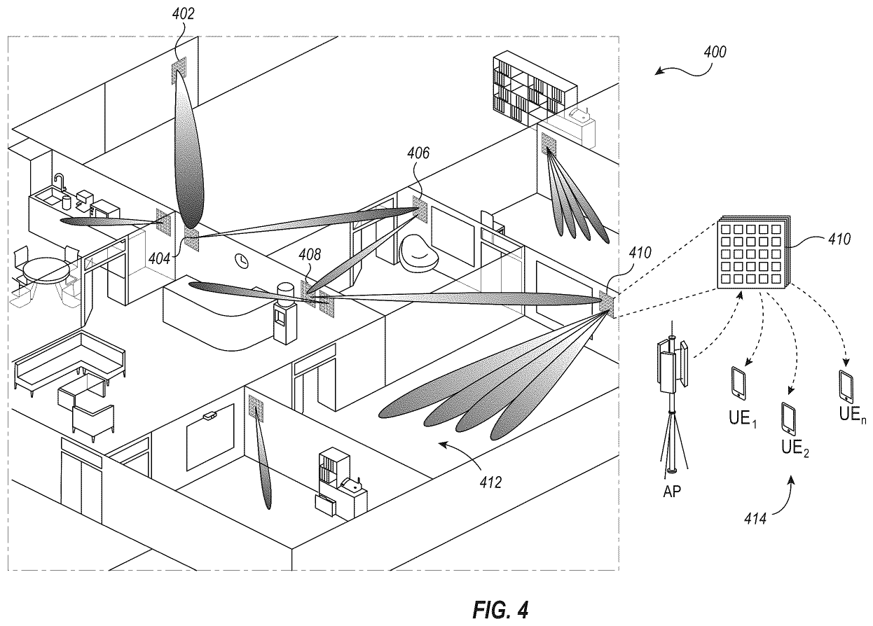

FIG. 4 discloses aspects of steering signals in an environment. FIG. 4 illustrates an indoor environment 400, such as a working environment (e.g., a building) of an entity. The indoor environment 400 may be cluttered with many obstructions, including walls, furniture, and appliances, which can block or degrade wireless signals, such as by way of example only mmWave signals. Reconfigurable intelligent surfaces (e.g., panels) can be strategically installed on walls, ceilings, or other surfaces, and can be used to reflect and steer these signals towards selected regions or locations. As illustrated in FIG. 4, reconfigurable intelligent surfaces may receive a signal from the indoor access point and redirect the signal to areas where the signal, which is transmitted by the gateway 402 or router is weak or non-existent. Embodiments of the invention may be used in multi-story buildings to direct signals to upper or lower floors.

Reconfigurable intelligent surfaces not only improve the coverage but can also improve the security of wireless communications. By selectively directing signals, the possibility of eavesdropping is reduced. Reconfigurable intelligent surface can add an additional layer of physical security by enabling secure transmission zones where only intended receivers can intercept the signals. The passive beamforming from reconfigurable intelligent surface improves energy efficiency by reducing wasteful signal dispersion and directing the signal only where required. Embodiments of the invention can be extended to smart homes where reconfigurable intelligent surfaces can intelligently steer signals towards connected devices like smart speakers, smart TVs, IoT sensors, etc., even when these devices are located in hard-to-reach areas.

More specifically, a wireless network may be established and include an access point 402 for the environment 400. Embodiments of the invention use panels that include multiple unit cells to steer or direct the signals. By way of example, panels 404, 406, 408, and 410 may be placed at various locations in the environment 400 (other panels are also illustrated). To provide wireless network coverage in the room 412, which may not receive a signal from the gateway 402, the signal transmitted by the gateway 402 is transmitted to the panel 404. The panel 404 includes unit cells that are configured to direct or reflect the signal to the panel 406. The panel 406 is configured to direct or reflect the signal to the panel 408. The panel 408 is configured to direct or reflect the signal to the panel 410.

The panel 410 may be configured to direct or reflect the signal in multiple directions, using for example different unit cell configurations such that the signal can be directed to or received by multiple user equipment 414 (e.g., UE₁, . . . , UEₙ), to provide wireless coverage to user equipment or other devices in the room 412 or other locations. A wireless path back to the access point 402 may be similarly configured and may use the same panels. However, movement of the user equipment may result in a different path using a different set of panels.

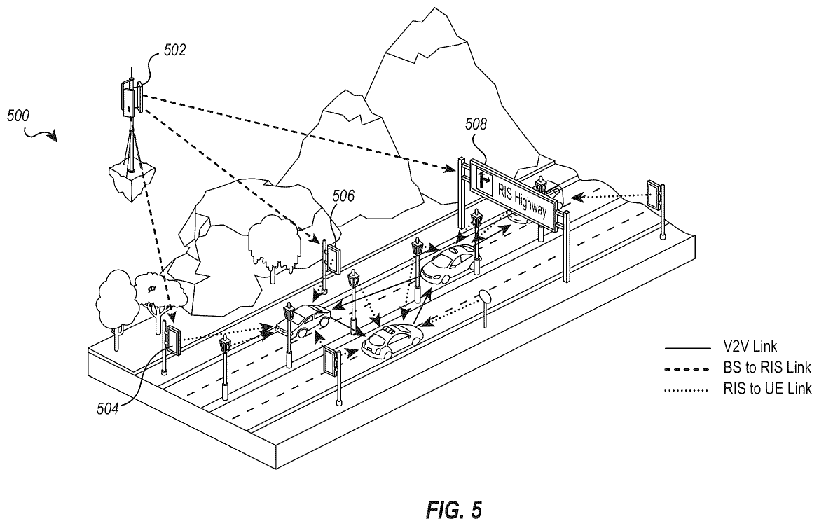

FIG. 5 discloses aspects of an environment in which reconfigurable intelligent surfaces may be deployed. FIG. 5 illustrates an outdoor environment 500 such as a highway or road. In this example, a base station 502 may broadcast a signal that can be redirected by panels placed in the environment 500. In this example, panels 504, 506, and 508 may be placed on overhead signs, lamp posts, road signs, and the like. This allows the signals to be redirected or reflected to provide coverage in the environment 500. Vehicle-to-vehicle (V2V) communication may be enabled using embodiments of the invention. V2V and autonomous vehicles benefit from high-speed, reliable, and low-latency wireless communication. Due to its high data rates, mmWave technology is considered as a potential enabler for these vehicular communication applications. However, the propagation characteristics of mmWave signals can be a limiting factor as mentioned previously.

As illustrated in FIG. 5, panels can be deployed in specific locations to reflect or refract mmWave signals towards the intended vehicle (or vehicles in a particular area), increasing the signal strength and improving the communication quality between vehicles. The coverage enhancement using reconfigurable intelligent surfaces is beneficial in vehicular networks as the vehicles may frequently go in and out of coverage areas. By extending the coverage of mmWave signals using reconfigurable intelligent surfaces, a smaller number of base stations and access points are needed. Reconfigurable intelligent surfaces can support Vehicle-to-Everything (V2X) communication, which involves communication between vehicles and any entity that may affect the vehicle, such as pedestrians, roadside infrastructure, or the network.

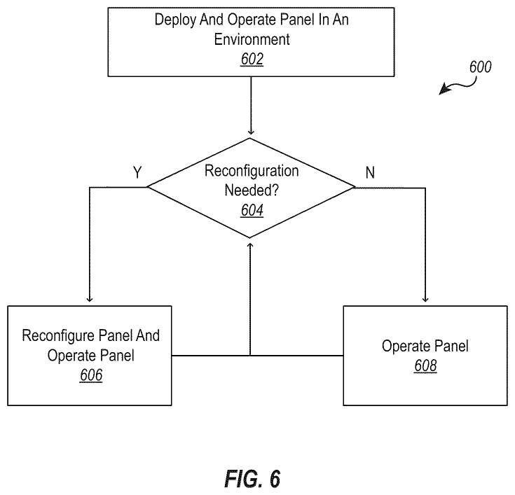

FIG. 6 discloses aspects of a method for redirecting signals or electromagnetic waves in an environment. The method 600 may include deploying and operating 602 a panel (or multiple panels) in an environment or a network. When deploying a panel, the panel may be selected or configured based on the frequency or frequencies of the environment. For example, the configuration of the top metal layer of the unit cells may be selected based on the intended frequencies in the environment. As previously stated, the top metal layer of the unit cells is configured to be resonant with certain frequencies.

Deploying and operating 602 a panel may also include connecting a panel to a power source (e.g., connecting each unit cell of the panel to a DC (direct current) power source). Each panel may also be connected to or include a controller or a computing device. The controller or computing device may be local, cloud-based, or the like. This allows panels to be configured or reconfigured remotely.

Aspects of the method 600 may be performed separately or as needed. Once a panel is deployed and operating, further changes may not be immediately necessary. In one embodiment, the panel may need to be reconfigured. Because the panel can redirect in a continuous manner, the desired steering direction may change because of changes in the environment, operational failure of other panels, or the like. If reconfiguration is necessary (Y at 604), the panel is reconfigured and operation continues 606. If reconfiguration is not necessary (N at 604), the panel continues to operate 608.

Panels can be arranged in different manners. For example, the unit cells of a specific panel can be configured to direct the incident signal in multiple directions (e.g., a portion of the unit cells are used for each direction). Alternatively, multiple panels may be used-one for each desired steering or reflection direction.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, signal processing operations, wireless coverage operations, signal steering or reflection operations, wireless coverage operations, or the like. More generally, the scope of the invention embraces any operating environment in which the disclosed concepts may be useful.

It is noted that any operation of any of the methods disclosed herein may be performed in response to, as a result of, and/or, based upon, the performance of any preceding operation. Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A unit cell comprising: a biasing layer, a first substrate formed on the biasing layer, a ground layer formed on the first substrate, a second substrate formed on the ground layer, a ferroelectric layer formed on the second substrate, a metal layer formed on the ferroelectric layer, and a first via and a second via electrically connecting the ferroelectric layer to the biasing layer, wherein the biasing layer is configured such that a voltage can be applied to the ferroelectric layer through the first and second via.

Embodiment 2. The unit cell of embodiment 1, wherein the first substrate comprises silicon or FR4 and wherein the second substrate comprises silicon, FR4, glass sapphire, quartz, or rogers RF.

Embodiment 3. The unit cell of embodiment 1 and/or 2, wherein the biasing layer and the ground layer comprise metal or are metallic.

Embodiment 4. The unit cell of embodiment 1, 2, and/or 3, wherein the ferroelectric layer covers only a portion of a top surface of the second substrate.

Embodiment 5. The unit cell of embodiment 1, 2, 3, and/or 4, wherein the ferroelectric layer comprises barium strontium titanate, BaTiO₃, PbTiO₃, Lead Zirconate Titanate, Triglycine Sulphate, PVDF, or Lithium tantalite.

Embodiment 6. The unit cell of embodiment 1, 2, 3, 4, and/or 5, wherein the metal

layer is shaped to be resonant to a range of frequencies.

Embodiment 7. The unit cell of embodiment 1, 2, 3, 4, 5, and/or 6, wherein the range of frequencies is greater than 30 GigaHertz, greater than 35 GigaHertz, less than 30 GigaHertz, or between 30 GigaHertz and 300 GigaHertz.

Embodiment 8. The unit cell of embodiment 1, 2, 3, 4, 5, 6, and/or 7, wherein the biasing layer comprises a first bias pad connected through the first via to a first side of the ferroelectric layer and a second bias pad connected through the second via to a second side of the ferroelectric layer.

Embodiment 9. The unit cell of embodiment 1, 2, 3, 4, 5, 6, 7, and/or 8, wherein dielectric constant of the ferroelectric layer changes according to a voltage placed across the ferroelectric layer using the first and second bias pads.

Embodiment 10. The unit cell of embodiment 1, 2, 3, 4, 5, 6, 7, 8, and/or 9, wherein a relative tunable phase of 360 degrees is achieved in a signal reflected by the unit cell by controlling the voltage applied to the ferroelectric layer.

Embodiment 11. The unit cell of embodiment 1, 2, 3, 4, 5, 6, 7, 8, 9, and/or 10, wherein the signal reflected by the unit cell is steerable to a specified direction by controlling the voltage.

Embodiment 12. A panel comprising: a plurality of unit cells arranged in a grid pattern, wherein each of the unit cells comprises: a biasing layer, a first substrate formed on the biasing layer, a ground layer formed on the first substrate, a second substrate formed on the ground layer, a ferroelectric layer formed on the second substrate, a metal layer formed the ferroelectric layer, and a first via and a second via electrically connecting the ferroelectric layer to the biasing layer, wherein the biasing layer is configured such that a voltage can be applied to the ferroelectric layer through the first and second via.

Embodiment 13. The panel of embodiment 12, wherein the first substrate comprises silicon, FR4, glass sapphire, quartz, or rogers RF and wherein the second substrate comprises silicon, FR4, glass sapphire, quartz, or rogers RF, and wherein and wherein the biasing layer and the ground layer comprise metal or are metallic and wherein the ferroelectric layer covers only a portion of a top surface of the second substrate.

Embodiment 14. The panel of embodiment 12 and/or 13, wherein the ferroelectric layer comprises barium strontium titanate, BaTiO₃, PbTiO₃, Lead Zirconate Titanate, Triglycine Sulphate, PVDF, or Lithium tantalite.

Embodiment 15. The panel of embodiment 12, 13, and/or 14, wherein the metal layer is shaped to be resonant to a range of frequencies, wherein the range of frequencies is greater than 30 GigaHertz, greater than 35 GigaHertz, greater than 40 GigaHertz, or between 30 GigaHertz and 300 GigaHertz.

Embodiment 16. The panel of embodiment 12, 13, 14, and/or 15, wherein the biasing layer comprises a first bias pad connected through the first via to a first side of the ferroelectric layer and a second bias pad connected through the second via to a second side of the ferroelectric layer and wherein the dielectric constant of the ferroelectric layer changes according to a voltage placed across the ferroelectric layer using the first and second bias pads.

Embodiment 17. The panel of embodiment 12, 13, 14, 15, and/or 16, wherein a relative tunable phase of 360 degrees is achieved in a signal reflected by the panel by controlling the voltage placed across the ferroelectric layers of the unit cells and wherein the signal reflected by the panel is steerable to a specified direction by controlling the voltage.

Embodiment 18. A method for steering a signal, the method comprising: operating a panel in an environment, the panel including unit cells, determining a direction for steering a signal, wherein the signal is received from a base station, an access point, or a different panel, and applying a voltage to each of the unit cells such that the signal is reflected in the determined direction, wherein each of the unit cells is configured to be controlled independently and wherein the voltage applied to each of the unit cells changes a dielectric of the unit cell.

Embodiment 19. The method of embodiment 18, further comprising reconfiguring the panel by applying a different voltage to the unit cells.

Embodiment 20. The method of embodiment 18 and/or 19, wherein each of the unit cells comprises: a metallic biasing layer, a first substrate formed on the biasing layer, a ground metal layer formed on the first substrate, a second substrate formed on the ground layer, a ferroelectric layer formed on the second substrate, a metal layer formed the ferroelectric layer, wherein the metal layer is configured to have a resonance with a signal having a frequency between 30 GigaHertz and 300 GigaHertz, and a first via and a second via electrically connecting the ferroelectric layer to the biasing layer, wherein the biasing layer is configured such that the voltage can be applied to the ferroelectric layer through the first and second via.

Embodiment 21. A non-transitory storage medium having stored therein instructions that are executable by one or more hardware processors to perform operations comprising the operations of any one or more of embodiments disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

As used herein, the term module, component, engine, agent, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

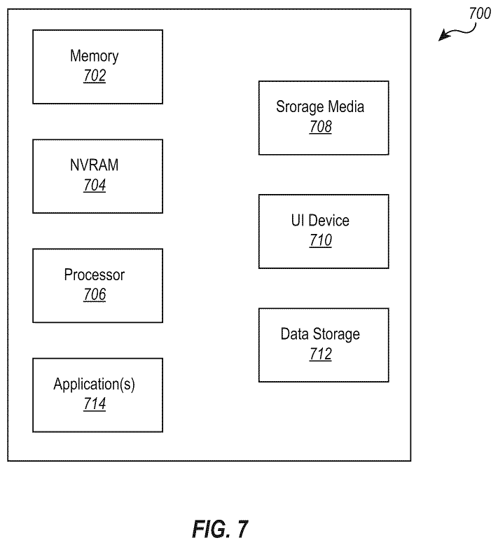

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A unit cell comprising:
a biasing layer;
a first substrate formed on the biasing layer;
a ground layer formed on the first substrate;
a second substrate formed on the ground layer;
a ferroelectric layer formed on the second substrate;
a metal layer formed on the ferroelectric layer; and
a first via and a second via electrically connecting the ferroelectric layer to the biasing layer, wherein the biasing layer is configured such that a voltage can be applied to the ferroelectric layer through the first and second via.

2. The unit cell of claim 1, wherein the first substrate comprises silicon, FR4, glass sapphire, quartz, or rogers RF and wherein the second substrate comprises silicon, FR4, glass sapphire, quartz, or rogers RF.

3. The unit cell of claim 1, wherein the biasing layer and the ground layer comprise metal or are metallic.

4. The unit cell of claim 1, wherein the ferroelectric layer covers only a portion of a top surface of the second substrate.

5. The unit cell of claim 1, wherein the ferroelectric layer comprises barium strontium titanate, BaTiO₃, PbTiO₃, Lead Zirconate Titanate, Triglycine Sulphate, PVDF, or Lithium tantalite.

6. The unit cell of claim 1, wherein the metal layer is shaped to be resonant to a range of frequencies.

7. The unit cell of claim 6, wherein the range of frequencies is greater than 30 GigaHertz, greater than 35 GigaHertz, less than 30 GigaHertz, or between 30 GigaHertz and 300 GigaHertz.

8. The unit cell of claim 1, wherein the biasing layer comprises a first bias pad connected through the first via to a first side of the ferroelectric layer and a second bias pad connected through the second via to a second side of the ferroelectric layer.

9. The unit cell of claim 8, wherein dielectric constant of the ferroelectric layer changes according to a voltage placed across the ferroelectric layer using the first and second bias pads.

10. The unit cell of claim 9, wherein a relative tunable phase of 360 degrees is achieved in a signal reflected by the unit cell by controlling the voltage applied to the ferroelectric layer.

11. The unit cell of claim 10, wherein the signal reflected by the unit cell is steerable to a specified direction by controlling the voltage.

12. A panel comprising:
a plurality of unit cells arranged in a grid pattern, wherein each of the unit cells comprises:
a biasing layer;
a first substrate formed on the biasing layer;
a ground layer formed on the first substrate;
a second substrate formed on the ground layer;
a ferroelectric layer formed on the second substrate;
a metal layer formed the ferroelectric layer; and
a first via and a second via electrically connecting the ferroelectric layer to the biasing layer, wherein the biasing layer is configured such that a voltage can be applied to the ferroelectric layer through the first and second via.

13. The panel of claim 12, wherein the first substrate comprises silicon, FR4, glass sapphire, quartz, or rogers RF and wherein the second substrate comprises silicon, FR4, glass sapphire, quartz, or rogers RF, and wherein and wherein the biasing layer and the ground layer comprise metal or are metallic and wherein the ferroelectric layer covers only a portion of a top surface of the second substrate.

14. The panel of claim 13, wherein the ferroelectric layer comprises barium strontium titanate, BaTiO₃, PbTiO₃, Lead Zirconate Titanate, Triglycine Sulphate, PVDF, or Lithium tantalite.

15. The panel of claim 12, wherein the metal layer is shaped to be resonant to a range of frequencies, wherein the range of frequencies is greater than 30 GigaHertz, greater than 35 GigaHertz, greater than 40 GigaHertz, less than 30 GigaHertz, or between 30 GigaHertz and 300 GigaHertz.

16. The panel of claim 12, wherein the biasing layer comprises a first bias pad connected through the first via to a first side of the ferroelectric layer and a second bias pad connected through the second via to a second side of the ferroelectric layer and wherein the dielectric constant of the ferroelectric layer changes according to a voltage placed across the ferroelectric layer using the first and second bias pads.

17. The panel of claim 16, wherein a relative tunable phase of 360 degrees is achieved in a signal reflected by the panel by controlling the voltage placed across the ferroelectric layers of the unit cells and wherein the signal reflected by the panel is steerable to a specified direction by controlling the voltage.

18. A method for steering a signal, the method comprising:
operating a panel in an environment, the panel including unit cells;
determining a direction for steering a signal, wherein the signal is received from a base station, an access point, or a different panel;
applying a voltage to each of the unit cells such that the signal is reflected in the determined direction, wherein each of the unit cells is configured to be controlled independently and wherein the voltage applied to each of the unit cells changes a dielectric of the unit cell.

19. The method of claim 18, further comprising reconfiguring the panel by applying a different voltage to the unit cells.

20. The method of claim 18, wherein each of the unit cells comprises:
a metallic biasing layer;
a first substrate formed on the biasing layer;
a ground metal layer formed on the first substrate;
a second substrate formed on the ground layer;
a ferroelectric layer formed on the second substrate;
a metal layer formed the ferroelectric layer, wherein the metal layer is configured to have a resonance with a signal having a frequency of interest; and
a first via and a second via electrically connecting the ferroelectric layer to the biasing layer, wherein the biasing layer is configured such that the voltage can be applied to the ferroelectric layer through the first and second via.
